(19) United States
(12) Patent Application Publication
(10) Pub. No.: US 2023/0413030 A1
(43) Pub. Date: Dec. 21, 2023

(54) WIRELESS RESOURCES CONTROLLER FOR MOBILE DEVICES

(71) Applicant: International Business Machines Corporation, Armonk, NY (US)

(72) Inventors: Manjit Singh Sodhi, Bangalore (IN); Sri Harsha Varada, Vizianagaram (IN); Manoj Kumar Goyal, Bangalore (IN); Rashmi Singh, Bangalore (IN)

(21) Appl. No.: 17/807,204

(22) Filed: Jun. 16, 2022

(51) Int. Cl. H04W 8/18; H04W 4/24; H04W 60/00

(52) U.S. Cl. CPC H04W 8/18; H04W 4/24; H04W 60/00

(57) ABSTRACT

Assigning wireless resources to a device based on usage context and predicting future demand for wireless resources. Connections to available wireless resources are made according to usage context and managed according to predicted future resource needs. An artificial intelligence prediction module and a supervised learning engine establish a proposed wireless resource usage plan. The available wireless resources are evaluated with reference to the usage plan and connections are made according to the evaluations.

### BACKGROUND

The present invention relates generally to the field of mobile devices, and more particularly to wireless resource management.

Wireless power transfer (WPT), also known as wireless power transmission, wireless energy transmission, or electromagnetic power transfer, is the transmission of electrical energy without wires as a physical link. In a wireless power transmission system, a transmitter device, driven by electric power from a power source, generates a time-varying electromagnetic field, which transmits power across space to a receiver device, which extracts power from the field and supplies it to an electrical load.

Wi-Fi or WiFi is a family of wireless network protocols, based on the IEEE 802.11 family of standards, which are commonly used for local area networking of devices and Internet access, allowing nearby digital devices to exchange data by radio waves. Wi-Fi is a wireless technology used to connect computers, tablets, smartphones, and other devices to the internet. Wi-Fi is the radio signal sent from a wireless router to a nearby device, which translates the signal into data you can see and use.

The term wireless resources as used herein includes: (i) WiFi networks; (ii) WPT sources (whether by induction, microwave, or laser beam), and (iii) other wireless network protocols for local area networking.

### SUMMARY

In one aspect of the present invention, a method, a computer program product, and a system includes: collecting contextual data related to usage of a user device by a user; storing the contextual data for historical analysis of various applications, including a first application, and corresponding usage metrics; receiving access datasets for a set of wireless resource providers, the access datasets including identifying credentials and payment information; generating a wireless resource usage model by analyzing the contextual data and the preference dataset with respect to the first application; determining a wireless resource requirement plan according to the wireless resource usage model; and establishing a connection to a selected wireless resource provider capable of meeting a requirement of the wireless resource requirement plan.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system; and

FIG. 4 is a block diagram view of a second embodiment of a system according to the present invention.

### DETAILED DESCRIPTION

Assigning wireless resources to a device based on usage context and predicting future demand for wireless resources. Connections to available wireless resources are made according to usage context and managed according to predicted future resource needs. An artificial intelligence prediction module and a supervised learning engine establish a proposed wireless resource usage plan. The available wireless resources are evaluated with reference to the usage plan and connections are made according to the evaluations. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

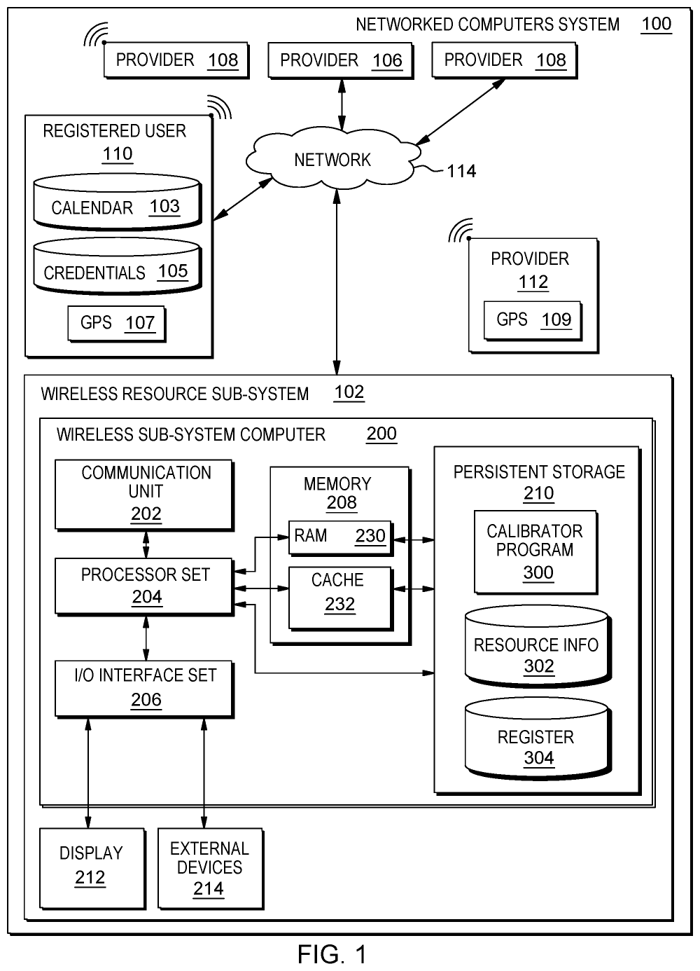

The present invention will now be described in detail with reference to the Figures. FIG. 1 is a functional block diagram illustrating various portions of networked computers system 100, in accordance with one embodiment of the present invention, including: wireless resource sub-system 102; wireless resource provider sub-systems 104, 106, 108, 112; registered user sub-system 110; calendar store 103; wireless resource credentials store 105; global positioning system (GPS) mod 107; communication network 114; wireless resource computer 200; communication unit 202; processor set 204; input/output (I/O) interface set 206; memory device 208; persistent storage device 210; display device 212; external device set 214; random access memory (RAM) devices 230; cache memory device 232; wireless resource calibrator program 300; wireless resource information store 302; and user registration store 304.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. While wireless providers 104, 112 are illustrated as communicating with registered user sub-system 110 directly via wireless connections other sub-systems may communicate via network 114 via wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Wireless resource calibration program 300 operates to identify and maintain wireless resources for usage according to predicted user needs. Wireless resource needs are determined according to user-preference and predicted usage. Predicted wireless resource needs are compared to available wireless resources for automated connection to wireless resources. Device usage is monitored to predict future wireless resource needs. When future needs are better served by alternative available wireless resources, wireless connections are dynamically updated according to predicted need.

Some embodiments of the present invention recognize the following facts, potential problems and/or potential areas for improvement with respect to the current state of the art: (i) users struggle to choose among available wireless resources including resources for wireless power transmission and for WiFi networks; (ii) there is no system available for recommending wireless resources according to specified preferences and usage context; (iii) the trial and error method for selecting a wireless resource such as wireless power or wireless network is inefficient; and/or (iv) there exists a need for a system that can dynamically and optimally identify the best wireless resources suitable for the user based on user preferences and context.

Some embodiments of the present invention are directed to selecting wireless resources from a set of wireless resources identified from nearby wireless resource providers with reference to specified constraints and predicted usage of the resources by a mobile device.

Some embodiments of the present invention are directed to selecting from related available wireless resources based on specified priorities of a target user and/or based on a usage context of a target user.

Some embodiments of the present invention are directed to mapping a contextual requirement for wireless resources to available wireless resources. Wireless resources include but are not limited to: (i) wireless power transfer (WPT) stations, (ii) WiFi networks; and (iii) other wireless network protocols for local area networking.

Some embodiments of the present invention are directed to meeting user-specified constraints including, but not limited to: (i) duration; (ii) continuity; (iii) budget; (iv) security; and (v) privacy.

Some embodiments of the present invention are directed to enabling a seamless toggle between different wireless resources and handling the related payment services seamlessly as configured by user beforehand. For example, if the user laptop is going low on power, the system will identify an appropriate wireless power transfer (WPT) provider nearby. The provider could even be another mobile device. Upon identifying the WPT provider, the system makes a payment agreement with that provider device and performs a seamless payment in keeping with the anticipated resource utilization. Similar activity may be performed with respect to accessing an identified wireless network.

Some embodiments of the present invention are directed to identifying or predicting exhaustion of WiFi resources or power of a mobile device while in use by analysis of different applications and their historical usage metrics in terms of power and network bandwidth. The analysis provides for predicting a possible deficit of wireless resources in near time. Responsive to a predicted shortage or exhaustion of wireless resources, the system may take preservation steps in preserving the current resources or to obtain additional wireless resources, such as wireless power transmission, before the predicted resource shortage occurs.

Some embodiments of the present invention are directed to using pre-paired devices from which to draw wireless resources prior to seeking external wireless resources. For example, a user may pair a mobile device and a tablet device before a meeting so that the power from these devices may be transferred from one to another when needed. If the combined devices do not have the necessary power, external power providers will be identified and selected according to the selected manner described herein. In one embodiment, while dealing a sensitive context, the system may fill the power of the pre-paired personal host devices by paying the external providers ahead of time to ensure maximum availability of power.

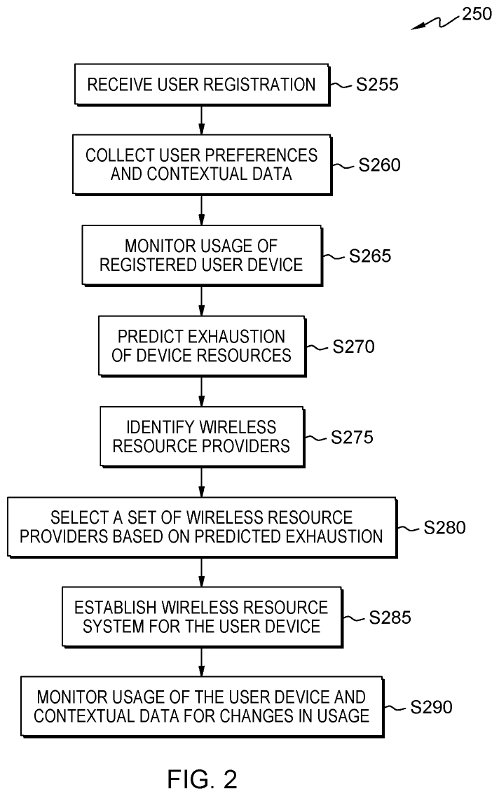

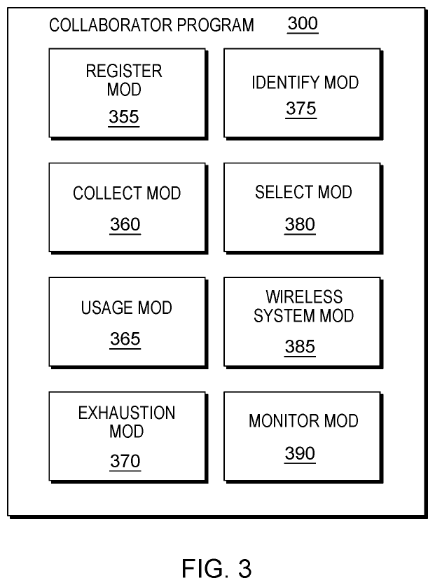

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where register module (“mod”) 355 receives user registration. In this example, a user operating registered user sub-system 110 registers with wireless resource sub-system 102 with the registration information be stored in register 304 (FIG. 1). While manner of registration can vary widely as well as the requirement of registration, the information obtained during registration in this example is helpful in the steps that follow when identifying wireless resource providers and determining what resources will be required by the user device.

Registration information, as discussed herein, includes, but is not limited to: (i) wireless device service provider; (ii) budget constraints for purchasing wireless resources including wireless power and WiFi services; (iii) wireless security requirements; (iv) privacy requirements; (v) pre-paired personal host devices that may provide needed wireless resources; (vi) calendar or other daily activity plans; (vii) wireless resource services for which the user has accounts; and/or (viii) pre-defined service provider restrictions and/or approvals for use.

Processing proceeds to step S260, where collect mod 360 collects user preferences and contextual data. In this example, each day that a user begins use of registered device 110, the collect mod collects relevant data from one or more of register store 304; resource information store 302; and calendar store 103 to assess current user preferences and projected usage context for the day. Alternatively, the collect mod collects data after each calendar event for use in orchestrating, or calibrating, wireless resources for a next period of time. Essentially, collect mod 360 operates to gather the available information for processing in the steps that follow. The extent of information that is gathered depends on what period of usage time is being evaluated. In some embodiments of the present invention, user-provided usage periods of the user device are defined at registration or prior to operation of the collect mod.

Processing proceeds to step S265, where usage mod 365 monitors usage of a registered user device. In this example, during use of the registered user device, usage mod monitors usage of applications and corresponding wireless resource consumption. Alternatively, continuous monitoring is performed to detect when usage begins. The term wireless resources, as used herein, refers to battery power and wireless networks (e.g. WiFi). Wireless resource providers are sources for wireless charging to increase battery power (wireless power transfer, WPT) and for wireless networks available for connection.

Usage mod may further operate to record usage history to, for example, resource information store 302 (FIG. 1), including, but not limited to: (i) applications used and corresponding battery usage rate and bandwidth requirements; (ii) frequency of use with respect to usage during each single day or over the course of multiple days; (iii) duration of application use; (iv) battery consumption during scheduled meetings or events; and (v) location-based bandwidth usage.

Processing proceeds to step S270, where exhaustion mod 370 predicts exhaustion of device resources. In this example, the exhaustion mod includes a machine learning engine for predicting expenditure of current resources of the registered user device, such as battery power or current WiFi connection. Exhausting mod 370 is location aware via tracking GPS 107 indicated location of the user device. Further, resource information store 302, includes WiFi availability mapping for pre-defined trajectories of the user device. Predicting the exhaustion of device resources includes evaluation of current battery power and WiFi connection with respect to scheduled events and/or application usage. Exhaustion mod 370 generates a wireless resource usage model for a specified period of time.

Processing proceeds to step S275, where identify mod 375 identifies available wireless resource providers. In this example, the identify mod accesses registered user sub-system 110 to identify available wireless resource providers over a wireless connection or via network 114 (FIG. 1). Regardless of the mechanism used to identify available wireless resource providers, identify mod 375 operates to generate a list of available wireless resource providers including wireless power providers and wireless network providers.

Processing proceeds to step S280, where select mod 380 selects a set of wireless resource providers based on predicted exhaustion. The set of wireless resource providers are selected from a list of identified available wireless resource providers. In this example, resource information store 302 includes preferred resource providers and excluded resource providers to facilitate selection of the set of wireless resource providers from the list generated at step S275. Alternatively, only wireless resources available without login credentials and those for which login credentials are provided in credentials store 105 are selected. Alternatively, the set of wireless resources includes wireless networks selected according to indicated strength of signal or according to measured speed of the wireless networks where a threshold strength or speed is defined by the wireless resource usage model.

Processing proceeds to step S285, where wireless system mod 385 establishes a wireless resource system for the registered user device. The wireless resource system may include location data for a wireless power resource. Further, with respect to mobile wireless power resources, directions and estimated distance for making contact with the resource may be provided. The wireless resource system may include available wireless network and wireless power from pre-paired devices available to the user. The wireless resource system is established to serve the user device over a specified period of time to avoid exhaustion of wireless resources according to predicted resource exhaustion. According to some embodiments of the present invention the established wireless resource system is presented to the user for review and approval. Where review and approval are incorporated into the process, a machine learning engine of the wireless system mod uses the review and/or approval as a feedback loop to train for establishing wireless resource systems for the user. According to some embodiments of the present invention, the established wireless resource system is adopted and any necessary payments for service providers is completed by the wireless system mod according to pre-defined payment methods.

Processing ends at step S290, where monitor mod 390 monitors usage of the registered user device and contextual data related to the user looking for changes in usage from the usage defined by usage mod 365 and changes in contextual data from collect mod 360. In this example, ongoing monitoring of usage of the registered user device is performed so that dynamic adjustments to wireless resource providers of the wireless resource system are made during use of the user device. For example, if a wireless network provider ceases operation, a next wireless network provider is selected by repeating steps S275 to S280. Further, if a wireless power resource is drained, particularly if a pre-paired resource becomes unavailable, processing returns to step S275 to identify an alternative, external wireless power resource.

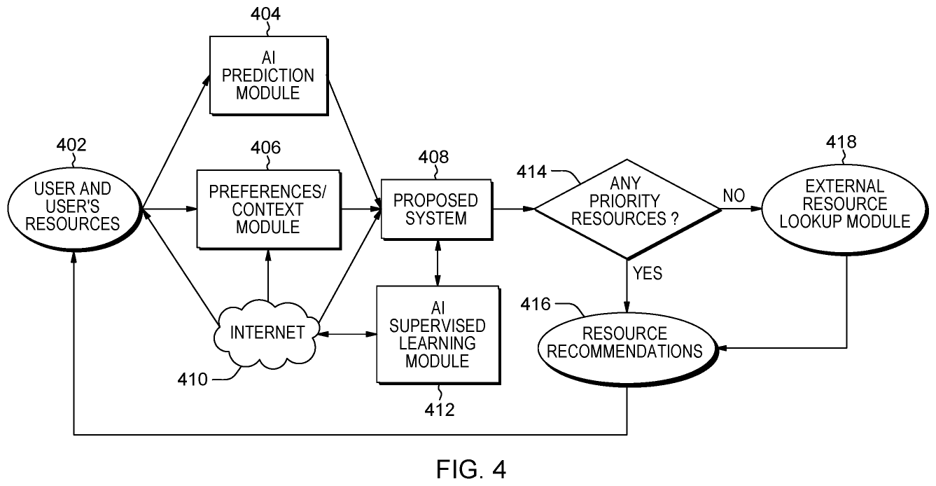

Further embodiments of the present invention are discussed in the paragraphs that follow and with reference to FIG. 4.

When a user tries to find a wifi network connection at a public place, there should be many options provided by different vendors, both paid and free resources. In general, the user may try to connect with a particular wifi network that appears to have good strength. But that may not be the best connection for the user because it may not be true that good wifi strength can provide the best speed, which is what the user may require.

There may also be many wireless power providers available, and the user requirement may be dynamic with respect to the need for device power. There may be a need to buy wireless power transmission from an available power provider.

Some embodiments of the present invention are directed to identifying wireless resources suitable for a mobile device based on user preferences and usage context.

An example user contextual requirement, or usage context, may be as follows: (i) the user will be boarding a train in fifteen minutes; (ii) the laptop power is currently at 20% power; (iii) the laptop is using Acme as the service provider; and (iv) the user will be attending a video meeting for thirty minutes while onboard the train. By taking the above context into account the system will determine the required wireless resources during for the trip.

In terms of wireless network, the video meeting may require a speed of 10 MBPS for thirty minutes. There may be two service providers available, one with a signal strength of 100% and a speed of 5 MBPS and another with a signal strength of 80% and a speed of 15 MBPS. In this case, the system will select the second service provider for the trip although it has a lower signal strength.

Additionally, preferred security policies or other user preference parameters may be applied to each service provider when selecting the service provider. The notion of security policy could be as simple as a need for the WiFi network to be from a provider having antivirus installed.

According to some embodiments of the present invention, an extended need for wireless resource may be identified or detected while monitoring mobile device activity. The extended need may be based on a predicted future need. Periodic review of current wireless resources with respect to future resource needs may be performed. When an extended need is detected, the system may notify the user of the need and/or may adjust the current usage context accordingly and re-calculate the wireless resource requirements. For example, if the system detects that a thirty-minute meeting has been extended by twenty more minutes, a revised wireless resource requirement may indicate that the current power level is insufficient. In such a case, some embodiments of the present invention automatically identify wireless resources to increase the power level to what is needed to complete the meeting. According to some embodiments of the present invention, identification of the resource and payment for the additional service is handled by the system according to pre-defined criteria.

Further, if the system determines that the user needs to download a large file, such as 10 GB, from internet during the fifty-minute meeting, the system will adjust the contextual requirement to include this new context and determine, for example, that 100 MBPS speed will be required for 10 minutes. Upon review of the available wireless network resources, the system may notify the user that a change in the network provider is needed, or, upon pre-approval, a change may be made automatically.

An example of helpfully predicting a shortfall of wireless resource is where historically the action of opening the visual studio and the Python anaconda library increases the power consumption and the context indicates that both applications are now opened. Accordingly, some embodiments of the present invention will recognize that there will be a surge of power usage in about ten minutes and may identify available wireless resources to handle the increased use of power if insufficient power is currently available. The system will add power before the current power is used up. Similarly, when additional WiFi bandwidth usage is predicted, where a current service is found to be inadequate for the future need, the system will establish an appropriate WiFi service provider before the current service provider no longer meets the needs of the user.

Some embodiments of the present invention are directed to a process including the following steps: (i) collecting identified contextual requirements of wireless resources and any preferential constraints associated with use of a mobile device; (ii) establishing the required wireless resources based on the collected inputs; (iii) toggling between wireless resource providers according to user-defined parameters; (iv) responsive to an expected change in context or preference, dynamically and automatically adjusting the contextual requirements and/or constraints and reestablishing the required wireless resources to meet the expected change; (v) predicting resource consumption and demand by utilizing an artificial intelligence prediction module thereby preserving the wireless resources or obtaining additional needed resources before their exhaustion; and (vi) facilitating user-defined and configured priority service providers for use in establishing the required wireless resources.

Some embodiments of the present invention are directed to mapping the user contextual requirement of wireless resources such as the following: WPT (wireless power), WiFi (wireless internet), and meeting the user preferential constraints such as of duration, continuity, budget, security, and privacy and calibrating the required wireless resources as needed.

Some embodiments of the present invention are directed to enabling the seamless toggle between different mobile wireless resources and handling the related payment services seamlessly as configured by user beforehand.

Some embodiments of the present invention are directed to using machine learning module to identify/predict possible expenditure of available resources in user current machine (mobile, laptop etc.) by using historical analysis of different applications and their usage metrics in terms of power, network, and other resources and predict possible deficit of resources from nearby wireless providers in near time thereby preserve the resources or lend the excess resources before they go deficit.

Some embodiments of the present invention are directed to having pre-paired personal host devices that are considered as priority wireless resource providers, being user prior to identifying external wireless resources.

According to some embodiments of the present invention, while dealing sensitive context, the system may fill the power of the pre-paired personal host devices by paying the external providers. These pre-paired host devices will be acting as back up to ensure 100% availability of resources.

FIG. 4 shows system 100 depicting a method according to an embodiment of the present invention. This method will now be discussed, over the course of the following paragraphs.

According to system 100, user device 402 is in communication with internet 410, preference module 406, and artificial intelligence module 404. Analysis of the usage of the user device by the prediction module and context module in conjunction with historic resources on the internet facilitates establishment of wireless resource requirements by proposed system module 408 supported by supervised machine learning module 412. Decision step 414 applies the wireless resource requirements to priority resources to identify whether or not certain commonly used or otherwise priority resource providers meet the requirements. If not, processing follows the “no” branch where the external resource lookup module 418 identifies external wireless resources to satisfy the established wireless resource requirements. If priority resources are available, processing proceeds from step 414 to step 416, where resource recommendations module applies the identified priority resources to establish the proposed system from step 408. If insufficient priority resources are available, the resource recommendations module applies external resources identified by external resource lookup module.

Some embodiments of the present invention are directed to a wireless power and network on-demand calibrator.

Some embodiments of the present invention are directed to a process including: (i) mapping contextual requirements of wireless resources like following but not limited to WPT (Wireless Power), WIFI (Wireless Internet) and meeting the user preferential constraints such as of duration, continuity, budget, security, privacy etc and calibrate the required wireless resources as needed; (ii) enabling a seamless toggle between different mobile wireless resources and handling the related payment services seamlessly as configured by user beforehand; (iii) responsive to detecting an extended need of the wireless resources, automatically notifying/adjusting the contextual requirements and re-calibrating the requirements for a wireless resource to meet the new preferential constraints; (iv) identifying or predicting, by a machine learning module, possible expenditure of available resources in user current machine (mobile, laptop) by using historical analysis of different applications and their usage metrics in terms of power, network, and other resources and predict possible deficit of resources from nearby wireless providers in near time thereby preserve the resources or lend the excess resources before they go deficit; (v) establishing pre-paired personal host devices that are considered as priority providers for the calibrator to use the resources prior to seeking resources from external providers; and (vi) responsive to dealing with sensitive context, satisfying the needed power of the pre-paired personal host devices by paying external providers for the necessary power (the pre-paired host devices serve as back up to ensure 100% availability of resources).

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
collecting contextual data related to usage of a user device by a user;
storing the contextual data for historical analysis of various applications, including a first application, and corresponding usage metrics;
receiving access datasets for a set of wireless resource providers, the access datasets including identifying credentials and payment information;
generating a wireless resource usage model by analyzing the contextual data and the preference dataset with respect to the first application;
determining a wireless resource requirement plan according to the wireless resource usage model; and
establishing a connection to a selected wireless resource provider capable of meeting a requirement of the wireless resource requirement plan.

2. The method of claim 1, further comprising:
detecting usage of the user device, the usage including the first application running on the user device.

3. The method of claim 1, further comprising:
monitoring usage of the user device for changes with respect to collected contextual data.

4. The method of claim 1, wherein the contextual data includes events and event locations to be attended by the user.

5. The method of claim 1, wherein the selected wireless resource provider is a wireless power transfer provider.

6. The method of claim 1, wherein establishing the connection includes transmitting an identifying credential and a payment based on an access dataset for the selected wireless resource provider.

7. The method of claim 1, wherein the selected wireless resource provider is a pre-paired personal host device.

8. A computer program product comprising a computer-readable storage medium having a set of instructions stored therein which, when executed by a processor, causes the processor to perform a method comprising:
collecting contextual data related to usage of a user device by a user;
storing the contextual data for historical analysis of various applications, including a first application, and corresponding usage metrics;
receiving access datasets for a set of wireless resource providers, the access datasets including identifying credentials and payment information;
generating a wireless resource usage model by analyzing the contextual data and the preference dataset with respect to the first application;
determining a wireless resource requirement plan according to the wireless resource usage model; and
establishing a connection to a selected wireless resource provider capable of meeting a requirement of the wireless resource requirement plan.

9. The computer program product of claim 8, further comprising:
detecting usage of the user device, the usage including the first application running on the user device.

10. The computer program product of claim 8, further comprising:
monitoring usage of the user device for changes with respect to collected contextual data.

11. The computer program product of claim 8, wherein the contextual data includes events and event locations to be attended by the user.

12. The computer program product of claim 8, wherein the selected wireless resource provider is a wireless power transfer provider.

13. The computer program product of claim 8, wherein establishing the connection includes transmitting an identifying credential and a payment based on an access dataset for the selected wireless resource provider.

14. The computer program product of claim 8, wherein the selected wireless resource provider is a pre-paired personal host device.

15. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a process comprising:
collecting contextual data related to usage of a user device by a user;
storing the contextual data for historical analysis of various applications, including a first application, and corresponding usage metrics;
receiving access datasets for a set of wireless resource providers, the access datasets including identifying credentials and payment information;
generating a wireless resource usage model by analyzing the contextual data and the preference dataset with respect to the first application;
determining a wireless resource requirement plan according to the wireless resource usage model; and
establishing a connection to a selected wireless resource provider capable of meeting a requirement of the wireless resource requirement plan.

16. The computer system of claim 15, further comprising:
monitoring usage of the user device for changes with respect to collected contextual data.

17. The computer system of claim 15, wherein the contextual data includes events and event locations to be attended by the user.

18. The computer system of claim 15, wherein the selected wireless resource provider is a wireless power transfer provider.

19. The computer system of claim 15, wherein establishing the connection includes transmitting an identifying credential and a payment based on an access dataset for the selected wireless resource provider.

20. The computer system of claim 15, wherein the selected wireless resource provider is a pre-paired personal host device.
